(19) United States
(12) Patent Application Publication
(10) Pub. No.: US 2025/0046021 A1
(43) Pub. Date: Feb. 6, 2025

(54) MERGING OVERLAPPING METAVERSE ENVIRONMENTS

(71) Applicant: International Business Machines Corporation, Armonk, NY (US)

(72) Inventor: Sarbajit K. Rakshit, Kolkata (IN)

(21) Appl. No.: 18/363,232

(22) Filed: Aug. 1, 2023

(51) Int. Cl. G06T 19/00; G02B 27/01; G06V 20/20

(52) U.S. Cl. CPC G06T 19/006; G02B 27/0172; G06V 20/20

(57) ABSTRACT

Embodiments of the invention are directed generating a merged metaverse environment from one or more overlapping metaverse environments. Aspects include obtaining a plurality of metaverse environments, wherein each of the plurality of metaverse environments corresponds to a geographic area and a time period and identifying two or more metaverse environments of the plurality of metaverse environments that are at least partially coincident. Aspects also include identifying objects in each of the two or more metaverse environments, wherein each of the objects includes a tag identifying a type of the object and receiving, from a user, a filter specifying types of objects to be included in a merged metaverse environment. Aspects further include creating, based on the two or more metaverse environments, the merged metaverse environment by combining the objects from the two or more metaverse environments based on the filter.

### BACKGROUND

The present invention relates in general to virtual reality environments, also referred to herein as metaverse environments. More specifically, the present invention relates to computing systems, computer-implemented methods, and computer program products for generating a merged metaverse environment from one or more overlapping metaverse environments.

In general, a virtual reality system can be used to generate and display a metaverse environment that includes video images, audio content, haptic feedback, and the like that simulate a real-world experience. A person can enter and leave the metaverse at any time using the virtual reality system. The basic components of a virtual reality system include a display, a computing system, and various feedback components that provide inputs from the user to the computing system.

Metaverse environments allow people located across the world to collaborate with each other and view avatars of each other in a shared virtual reality. Metaverse environments can be used for business meetings, interviews, and office collaborations, where people across the world can collaborate with each other. Often, different metaverse environments are utilized for different types of collaborations or meetings so that an appropriate ambiance for the collaboration can be created.

### SUMMARY

Embodiments of the invention provide a computer-implemented method for generating a merged metaverse environment from one or more overlapping metaverse environments. Aspects include obtaining a plurality of metaverse environments, wherein each of the plurality of metaverse environments corresponds to a geographic area and a time period and identifying two or more metaverse environments of the plurality of metaverse environments that are at least partially coincident. Aspects also include identifying objects in each of the two or more metaverse environments, wherein each of the objects includes a tag identifying a type of the object and receiving, from a user, a filter specifying types of objects to be included in a merged metaverse environment. Aspects further include creating, based on the two or more metaverse environments, the merged metaverse environment by combining the objects from the two or more metaverse environments based on the filter.

Embodiments of the invention also provide computer-implemented methods and/or computer program products having substantially the same features as the computer system described above.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts details of an exemplary computing environment operable to implement various aspects of the invention.

FIG. 2 depicts a block diagram illustrating a virtual reality system according to embodiments of the invention;

FIG. 3 depicts details of a head-mounted-device (HMD) of the virtual reality system according to embodiments of the invention;

FIG. 4 depicts a user interface for identifying metaverse environments for creating a merged metaverse environment according to embodiments of the invention;

FIGS. 5A, 5B, and 5C depict user interfaces for creating a merged metaverse environment according to embodiments of the invention; and

FIG. 6 depicts a flowchart diagram of a method for creating a merged metaverse environment according to embodiments of the invention.

In the accompanying figures and following detailed description of the disclosed embodiments, the various elements illustrated in the figures are provided with three-digit reference numbers. In some instances, the leftmost digits of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The term “metaverse” describes a variety of VR environments, including highly immersive internet-based 3-D or virtually integrated environments. A metaverse environment can also be described as an online “place” where physical, virtual, and augmented realities are shared. In an example implementation, activities of teams that need to collaborate to perform a task can, in theory, be performed by remotely-located collaborators meeting and performing collaboration activities in a metaverse environment. A metaverse collaboration environment could, if practically implemented as a replacement for a corresponding physical environment, save on power, space utilization, rent, and the ability to retain employees. VR headsets could further enhance the experience of a metaverse collaboration environment by incorporating 3D graphics (e.g., augmented reality), customizable dashboards, and other elements. The collaborators would not need to be in the same room if they are in the same “virtual space,” thus enabling them to collaborate even more effectively. The ability to virtually “travel” to various “places” in the metaverse could enable an operator to virtually visit any number of remote physical locations and interface efficiently with the systems at the remote physical locations.

Despite the potential benefits of performing collaboration activities in a VR (or metaverse) environment, there are challenges to realizing the above-described benefits of using VR/metaverse environments when performing semi-collaborative activities on-line communities of people who share a common experience. For example, a book discussion club is a group of people who meet to discuss a book or books that they have read and express their opinions, likes, dislikes, etc. Book discussion clubs meet in private homes, libraries, bookstores, online forums, pubs, in cafés, in restaurants, or over meals. Online forums are often informal and can involve members who have never met one another in person but have come together because of interest in a particular subject.

To facilitate online collaboration activities, users often select a metaverse environment to conduct their meetings in. In some cases, the metaverse environments correspond to actual real-world physical locations at a specific point in time. In addition, once a user, or set of users, creates a metaverse environment, it may be made publicly available for other individuals to use. Different users, or sets of users, can create metaverse environments that can overlap between geographically and temporally. Embodiments include methods, systems, and computer program products for merging multiple overlapping metaverse environments to create a single merged metaverse environment. As a result, the metaverse environment provided to a user for collaboration is a more complete and robust metaverse environment.

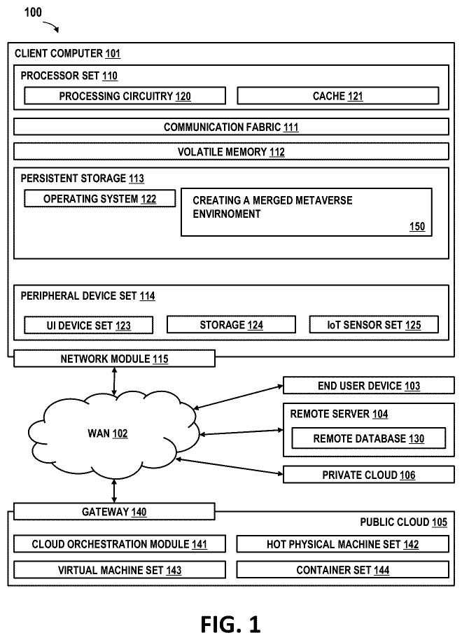

FIG. 1 depicts an example computing environment 100 that can be used to implement aspects of the invention. Computing environment 100 contains an example of an environment for the execution of at least some of the computer code involved in performing the inventive methods, such as creating merged metaverse environments (block) 150. In addition to block 150, computing environment 100 includes, for example, computer 101, wide area network (WAN) 102, end-user device (EUD) 103, remote server 104, public cloud 105, and private cloud 106. In this embodiment, computer 101 includes processor set 11 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 11 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 11. Cache memories are typically organized into multiple levels depending upon relative proximity to the processing circuitry. Alternatively, some, or all, of the cache for the processor set may be located “off chip.” In some computing environments, processor set 11 may be designed for working with qubits and performing quantum computing.

Computer readable program instructions are typically loaded onto computer 101 to cause a series of operational steps to be performed by processor set 11 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 11 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

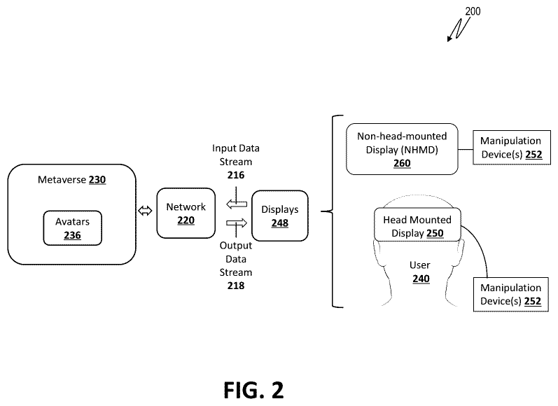

Turning now to a more detailed description of the aspects of the invention, FIG. 2 depicts a diagram illustrating a VR system 200 according to embodiments of the invention. In aspects of the invention, the system 200 is a 3D immersive video system that includes a metaverse 230 in communication with head mounted display 250 (e.g., user displays) over a network 220, such as the Internet. In one embodiment, the metaverse 230 is embodied in a computing environment 100, such as the one shown in FIG. 1 In some embodiment of the invention, the system 200 processes and displays immersive videos or spherical videos (e.g., 360-degree videos, 180-degree video, and the like), which are video recordings where a view in every direction (or in multiple directions) is recorded at the same time using, for example, an omnidirectional camera or a collection of cameras.

In exemplary embodiments, a user 240 interfaces with the metaverse 230 using display 248. Although only one user 240 is shown any number of users 240 can be provided. In embodiments of the invention, the displays 248 can be implemented as a head-mounted display (HMD) 250 or a non-HMD (NHMD) 260. The NHMD 260 can be a stand-alone flat panel display, or a flat panel display integrated with another device such as a smartphone or a laptop. The HMD 250 is configured to be worn by the user 240. Both the HMD 250 and the NHMD 260 can be in wired or wireless communication with manipulation device(s) 252 (e.g., a three-dimensional mouse, data gloves, etc.) configured to be worn by and/or otherwise controlled/used by the user 240. The metaverse 230 is in wired and/or wireless communication with the display(s) 248. In embodiments of the invention, the metaverse 230 an avatar 236 that represents the user 240.

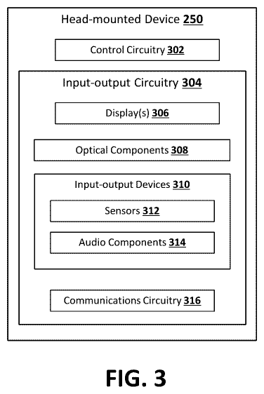

FIG. 3 depicts an HMD 250, which is a non-limiting example of how the HMD 250 can be implemented. In accordance with aspects of the invention, the HMD 250 includes control circuitry 302 and input-output circuitry 304, configured and arranged as shown. The input-output circuitry 304 includes display(s) 306, optical components 308, input-output devices 310, and communications circuitry 318, configured and arranged as shown. The input-output devices 310 include sensors 312 and audio components 314, configured and arranged as shown. The various components of the HMD 250 can be supported by a head-mountable support structure such as a pair of glasses; a helmet; a pair of goggles; and/or other head-mountable support structure configurations.

In embodiments of the invention, the control circuitry 302 can include storage and processing circuitry for controlling the operation of the HMD 250. The control circuitry 302 can include storage such as hard disk drive storage, nonvolatile memory (e.g., electrically-programmable-read-only memory configured to form a solid-state drive), volatile memory (e.g., static or dynamic random-access-memory), etc. Processing circuitry in the control circuitry 302 can be based on one or more microprocessors, microcontrollers, digital signal processors, baseband processors, power management units, audio chips, graphic processing units, application specific integrated circuits, and other integrated circuits. Computer program instructions can be stored on storage in the control circuitry 302 and run on processing circuitry in the control circuitry 302 to implement operations for HMD 250 (e.g., data gathering operations, operations involving the adjustment of components using control signals, image rendering operations to produce image content to be displayed for a user, etc.).

The input-output circuitry 304 can be used to allow the HMD 250 to receive data from external equipment; a portable device such as a handheld device; a laptop computer; or other electrical equipment) and to allow the user 240 (shown in FIG. 2) to provide the HMD 250 with user input. The input-output circuitry 304 can also be used to gather information on the environment in which HMD 250 is operating. Output components in the input-output circuitry 304 can allow the HMD 250 to provide the user 240 with output and can be used to communicate with external electrical equipment.

Display(s) 306 of the input-output circuitry 304 can be used to display images to the user 240 (shown in FIG. 2) of the HMD 250. The display(s) 306 can be configured to have pixel array(s) to generate images that are presented to the user 240 through an optical system. The optical system can, if desired, have a transparent portion through which the user 240 (viewer) can observe real-world objects while computer-generated content is overlaid on top of the real-world objects by producing computer-generated images on the display(s) 206. In embodiments of the invention, the display(s) 206 are immersive views of the full 360-degree video frame 300, wherein the display(s) 206 place tiny screens and lenses close to the user's eyes to simulate large screens that encompass most of the user's field of view. As the user 240 performs actions like walking, head rotating (i.e., changing the point of view), data describing behavior of the user 240 is fed to the metaverse 230 (shown in FIG. 2) from the HMD 250 and/or the manipulation devices 252 (shown in FIG. 2).

The optical components 308 can be used in forming the optical system that presents images to the user 240. The optical components 208 can include static components such as waveguides, static optical couplers, and fixed lenses. The optical components 208 can also include adjustable optical components such as an adjustable polarizer, tunable lenses (e.g., liquid crystal tunable lenses; tunable lenses based on electro-optic materials; tunable liquid lenses; microelectromechanical system tunable lenses; or other tunable lenses), a dynamically adjustable coupler, and other optical devices formed from electro-optical materials (e.g., lithium niobate or other materials exhibiting the electro-optic effect). The optical components 208 can be used in receiving and modifying light (images) from the display 306 and in providing images to the user 240 for viewing. In some embodiments of the invention, one or more of the optical components 208 can be stacked so that light passes through multiple of the components 308 in series. In embodiments of the invention, the optical components 208 can be spread out laterally (e.g., multiple displays can be arranged on a waveguide or set of waveguides using a tiled set of laterally adjacent couplers). In some embodiments of the invention, both tiling and stacking configurations are present.

The input-output devices 310 of the input-output circuitry 204 are configured to gather data and user input and for supplying the user 240 (shown in FIG. 2) with output. The input-output devices 310 can include sensors 312, audio components 314, and other components for gathering input from the user 240 and/or or the environment surrounding the HMD 250 and for providing output to the user 240. The input-output devices 310 can, for example, include keyboards; buttons; joysticks; touch sensors for trackpads and other touch sensitive input devices; cameras; light-emitting diodes; and/or other input-output components. For example, cameras or other devices in the input-output circuitry 304 can face the eyes of the user 240 and track the gaze of the user 240. The sensors 312 can include position and motion sensors, which can include, for example, compasses; gyroscopes; accelerometers and/or other devices for monitoring the location, orientation, and movement of the HMD 250; and satellite navigation system circuitry such as Global Positioning System (GPS) circuitry for monitoring location of the user 240. The sensors 312 can further include eye-tracking functionality. Using the sensors 312, for example, the control circuitry 302 can monitor the current direction in which a user's head is oriented relative to the surrounding environment. Movements of the user's head (e.g., motion to the left and/or right to track on-screen objects and/or to view additional real-world objects) can also be monitored using the sensors 312.

In some embodiments of the invention, the sensors 312 can include ambient light sensors that measure ambient light intensity and/or ambient light color; force sensors; temperature sensors; touch sensors; capacitive proximity sensors; light-based proximity sensors; other types of proximity sensors; strain gauges; gas sensors; pressure sensors; moisture sensors; magnetic sensors; and the like. The audio components 314 can include microphones for gathering voice commands and other audio input and speakers for providing audio output (e.g., ear buds, bone conduction speakers, or other speakers for providing sound to the left and right ears of a user). In some embodiments of the invention, the input-output devices 310 can include haptic output devices (e.g., vibrating components); light-emitting diodes and other light sources; and other output components. The input-output circuitry 304 can include wired and/or wireless communications circuitry 316 that allows the HMD 250 (e.g., using the control circuitry 302) to communicate with external equipment (e.g., remote controls, joysticks, input controllers, portable electronic devices, computers, displays, and the like) and that allows signals to be conveyed between components (circuitry) at different locations in the HMD 250.

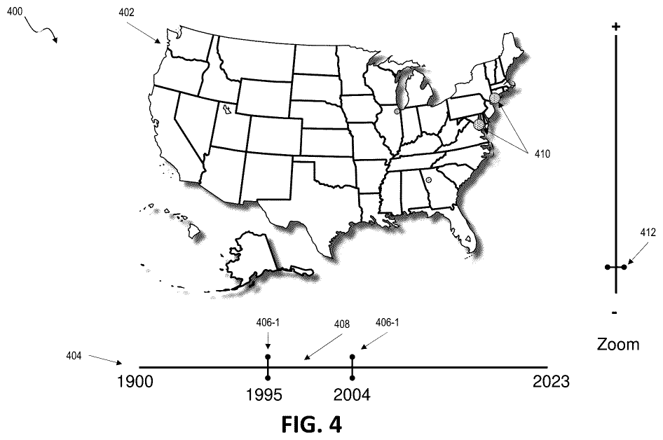

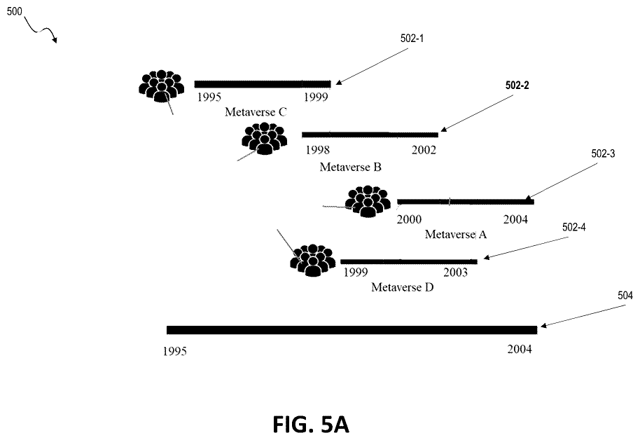

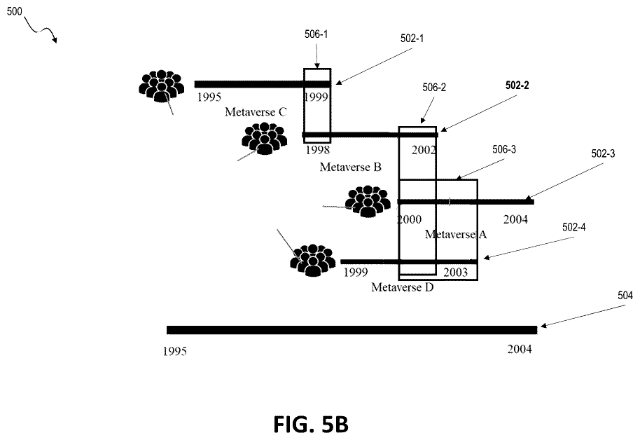

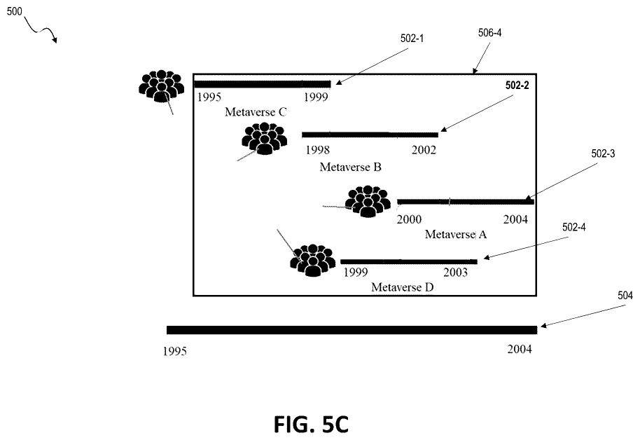

Referring now to FIG. 4, a user interface 400 for identifying metaverse environments for creating a merged metaverse environment according to embodiments of the invention is shown. As illustrated, the user interface 400 includes a map 402 that is displayed with indicators 410 of one or more available metaverse environments. The user interface 400 also includes a zoom tool 412 that allow a user to zoom in and out on the map 402. The user interface 400 further includes a timeline 404 that includes selection items 406-1, 406-2 that are used to define a time period 408. In exemplary embodiments, as the user adjusts the selection items 406-1, 406-2 and zoom tool 412 the map 402 is responsively updated to provide indicators 410 of one or more available metaverse environments that correspond to the time period 408. In one embodiment, the location of the indicators 410 of one or more available metaverse environments correspond to the physical locations of the metaverse environments. In exemplary embodiments, when an indicator 410 that corresponds to two or more overlapping metaverse environments is selected a merged metaverse can be created using the user interfaces depicted in one or more of FIGS. 5A, 5B and 5C.

Referring now to FIGS. 5A, 5B and 5C, user interfaces 500 for creating a merged metaverse environment according to embodiments of the invention are shown. As illustrated, the user interface 500 displays a plurality of metaverse environments 502-1, 502-2, 502-3, and 502-4, referred to herein collectively as metaverse environments 502. In one embodiment, the metaverse environments 502 are displayed in response to the user selecting an indicator 410 from the user interface 400 (shown in FIG. 4). As a result, each of the metaverse environments 502 includes at least a partially overlapping geographic region. In addition, as illustrated, each of the metaverse environments 502 includes a time period that is defined by a starting date and an ending date that fall within the time period 504, which may be specified by the user via user interface 400 (shown in FIG. 4).

In exemplary embodiments, the user can select which of the metaverse environments 502 to include the merged metaverse environments 506. In one embodiment, as best shown in FIG. 5B, a plurality of merged metaverse environments 506-1, 506-2, and 506-3, referred to herein collectively as merged metaverse environments 506, are created by merging the portions of the metaverse environments 502 that overlap in time. For example, merged metaverse environment 506-1 is created by merging metaverse environments 502-1 and 502-2, merged metaverse environment 506-2 is created by merging metaverse environments 502-2, 502-3, and 502-4, and merged metaverse environment 506-3 is created by merging metaverse environments 502-3 and 502-4. In another embodiment, as best shown in FIG. 5C, a single merged metaverse environment 506-4, is created by merging all of the metaverse environments 502-1, 502-2, 502-3, and 502-4.

In exemplary embodiments, merging two metaverse environments includes identifying all of the objects in each metaverse environments, removing duplicate objects, and combining the remaining objects for the merged metaverse environment. In exemplary embodiments, each of the objects in the metaverse environments includes one or more tags that are used to identify a type of each object. The object types can include, but are not limited to, building types, people types, dynamic object types, static object types, people object types, animal object types, and the like. In exemplary embodiments, when a user selects to create a merged metaverse environment, the user may provide a filter that is used to select one or more object types to include or exclude from the merged metaverse environment.

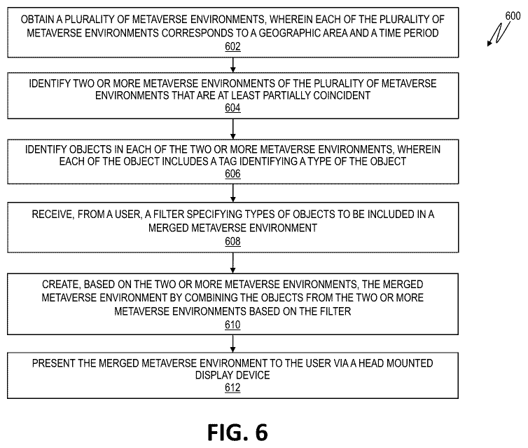

Referring now to FIG. 6, a flowchart diagram of a method 600 for creating a merged metaverse environment according to embodiments of the invention is shown. In exemplary embodiments, the method 600 is performed by a computing environment 100, such as the one shown in FIG. 1.

At block 602, the method 600 includes obtaining a plurality of metaverse environments and each of the plurality of metaverse environments corresponds to a geographic area and a time period. In exemplary embodiments, the plurality of metaverse environments are obtained from one or more publicly available sources, such as a metaverse environment database. In one embodiment, each metaverse environment stored in the metaverse environment database includes metadata that specifies a geographic area of the metaverse environment and a time period of the metaverse environment. In one embodiment, the plurality of metaverse environments are obtained in response to a request received from a user, where the request includes a desired geographic area and a desired time period for the metaverse environment. The request can be generated by the use through a graphical user interface, such as the one shown in FIG. 4, that displays a map of available metaverse environments and that includes an element that allows the user to specify the desired time period.

At block 604, the method 600 includes identifying two or more metaverse environments of the plurality of metaverse environments that are at least partially coincident. In exemplary embodiments, identifying the two or more metaverse environments of the plurality of metaverse environments that are at least partially coincident includes determining that the geographic area of the two or more metaverse environments at least partially overlap and that the time period of the two or more metaverse environments are at least partially concurrent. In other words, two metaverse environments that have some geographic and temporal overlap would be considered to be coincident.

In exemplary embodiments, the two or more metaverse environments of the plurality of metaverse environments are further identified based on determining that the geographic area of the two or more metaverse environments at least partially overlap the desired geographic area and that the time period of the two or more metaverse environments at least partially overlap the desired time period. For example, in addition to the two or more metaverse environments being coincident with one another, each of the two or more metaverse environments are coincident with, i.e., they have geographic and temporal overlap, the user provided desired geographic area and desired time period.

At block 606, the method 600 includes identifying objects in each of the two or more metaverse environments, wherein each of the objects includes a tag identifying a type of the object. In exemplary embodiments, once the two or more metaverse environments are identified all of the objects that make up the two or more metaverse environments are identified. These objects can include, but are not limited to, buildings, people, vehicles, natural elements (trees, animals, clouds, and the like), roads, furniture, and the like. In exemplary embodiments, the tag for each object identifies a type of the object and optionally a location of the object in the metaverse environment and a description of the object. For example, an object of a building may include a tag that specifies a building type, identifies a physical location of the building in the metaverse environment, and provides a description of the building.

Next, as shown at block 608, the method 600 includes receiving, from a user, a filter specifying types of objects to be included in a merged metaverse environment. In one embodiment, the filter includes an identification of one or more types of objects to be included in the merged metaverse environment and one or more types of objects to be excluded from the merged metaverse environment. For example, a user may provide a filter that elects to include building objects and natural objects but that excludes people objects from the merged metaverse environment.

At block 610, the method 600 includes creating, based on the two or more metaverse environments, the merged metaverse environment by combining the objects from the two or more metaverse environments based on the filter. In exemplary embodiments, creating the merged metaverse environment further includes identifying common objects that are present in both of the two or more metaverse environments and selecting one of the common objects to be part of the merged metaverse environment. In one embodiment, the selection of one of the common objects can be based on a resolution of common objects, for example, a higher resolution or better-quality representation of the common object will be selected.

In one embodiment, the merged metaverse environment includes a geographic area that is a combination of the geographic area of the two or more metaverse environments and a time period that is a combination of the time periods of the two or more metaverse environments. In another embodiment, the merged metaverse environment includes a geographic area that consists of a common geographic area of the two or more metaverse environments and a time period that consists of a common time period of the two or more metaverse environments.

At block 612, the method 600 includes presenting the merged metaverse environment to the user via a head-mounted display device. In embodiments where the plurality of metaverse environments are obtained from a database including publicly available metaverse environments, the method also includes storing the merged metaverse environment in the database.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” and variations thereof are used herein to mean “serving as an example, instance or illustration.” Any embodiment or design described herein as “exemplary” is not necessarily to be construed as preferred or advantageous over other embodiments or designs. The terms “at least one,” “one or more,” and variations thereof, can include any integer number greater than or equal to one, i.e. one, two, three, four, etc. The terms “a plurality” and variations thereof can include any integer number greater than or equal to two, i.e., two, three, four, five, etc. The term “connection” and variations thereof can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The phrases “in signal communication”, “in communication with,” “communicatively coupled to,” “electronically coupled to” and variations thereof can be used interchangeably herein and can refer to any coupling, connection, or interaction using electrical signals to exchange information or data, using any system, hardware, software, protocol, or format, regardless of whether the exchange occurs wirelessly or over a wired connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It will be understood that those skilled in the art, both now and in the future, may make various improvements and enhancements which fall within the scope of the claims which follow.

What is claimed is:

1. A computer-implemented method comprising:
obtaining a plurality of metaverse environments, wherein each of the plurality of metaverse environments corresponds to a geographic area and a time period;
identifying two or more metaverse environments of the plurality of metaverse environments that are at least partially coincident;
identifying objects in each of the two or more metaverse environments, wherein each of the objects includes a tag identifying a type of the object;
receiving, from a user, a filter specifying types of the objects to be included in a merged metaverse environment; and
creating, based on the two or more metaverse environments, the merged metaverse environment by combining the objects from the two or more metaverse environments based on the filter.

2. The computer-implemented method of claim 1, wherein identifying the two or more metaverse environments of the plurality of metaverse environments that are at least partially coincident includes determining that the geographic area of the two or more metaverse environments at least partially overlap and that the time period of the two or more metaverse environments are at least partially concurrent.

3. The computer-implemented method of claim 1, wherein creating the merged metaverse environment further includes identifying common objects that are present in both of the two or more metaverse environments and selecting one of the common objects to be part of the merged metaverse environment.

4. The computer-implemented method of claim 1, further comprising receiving a request for the merged metaverse environment from the user, wherein the request includes a desired geographic area and a desired time period.

5. The computer-implemented method of claim 4, wherein the two or more metaverse environments of the plurality of metaverse environments are further identified based on determining that the geographic area of the two or more metaverse environments at least partially overlap the desired geographic area and that the time period of the two or more metaverse environments at least partially overlap the desired time period.

6. The computer-implemented method of claim 4, wherein the request for the merged metaverse environment from the user is created by the user selecting the desired geographic area on a map displayed on a graphical user interface.

7. The computer-implemented method of claim 1, wherein the plurality of metaverse environments are obtained from a database including publicly available metaverse environments and wherein the computer-implemented method further comprises storing the merged metaverse environment in the database.

8. The computer-implemented method of claim 1, wherein the merged metaverse environment includes the geographic area that is a combination of the geographic area of the two or more metaverse environments and a time period that is a combination of the time periods of the two or more metaverse environments.

9. The computer-implemented method of claim 1, wherein the merged metaverse environment includes a geographic area that consists of a common geographic area of the two or more metaverse environments and a time period that consists of a common time period of the two or more metaverse environments.

10. The computer-implemented method of claim 1, further comprising presenting the merged metaverse environment to the user via a head-mounted display device.

11. A computer system comprising a processor electronically coupled to a memory, wherein the processor performs processor operations comprising:
obtaining a plurality of metaverse environments, wherein each of the plurality of metaverse environments corresponds to a geographic area and a time period;
identifying two or more metaverse environments of the plurality of metaverse environments that are at least partially coincident;
identifying objects in each of the two or more metaverse environments, wherein each of the objects includes a tag identifying a type of the object;
receiving, from a user, a filter specifying types of the objects to be included in a merged metaverse environment; and
creating, based on the two or more metaverse environments, the merged metaverse environment by combining the objects from the two or more metaverse environments based on the filter.

12. The computer system of claim 11, wherein identifying the two or more metaverse environments of the plurality of metaverse environments that are at least partially coincident includes determining that the geographic area of the two or more metaverse environments at least partially overlap and that the time period of the two or more metaverse environments are at least partially concurrent.

13. The computer system of claim 11, wherein creating the merged metaverse environment further includes identifying common objects that are present in both of the two or more metaverse environments and selecting one of the common objects to be part of the merged metaverse environment.

14. The computer system of claim 11, wherein the operations further comprise receiving a request for the merged metaverse environment from a user, wherein the request includes a desired geographic area and a desired time period.

15. The computer system of claim 14, wherein the two or more metaverse environments of the plurality of metaverse environments are further identified based on determining that the geographic area of the two or more metaverse environments at least partially overlap the desired geographic area and that the time period of the two or more metaverse environments at least partially overlap the desired time period.

16. The computer system of claim 14, wherein the request for the merged metaverse environment from the user is created by the user selecting the desired geographic area on a map displayed on a graphical user interface.

17. The computer system of claim 11, wherein the plurality of metaverse environments are obtained from a database including publicly available metaverse environments and wherein the computer-implemented method further comprises storing the merged metaverse environment in the database.

18. The computer system of claim 11, wherein the merged metaverse environment includes the geographic area that is a combination of the geographic area of the two or more metaverse environments and a time period that is a combination of the time periods of the two or more metaverse environments.

19. The computer system of claim 11, wherein the merged metaverse environment includes a geographic area that consists of a common geographic area of the two or more metaverse environments and a time period that consists of a common time period of the two or more metaverse environments.

20. A computer program product comprising a computer readable program stored on a computer readable storage medium, wherein the computer readable program, when executed on a processor system, causes the processor system to perform processor operations comprising:
obtaining a plurality of metaverse environments, wherein each of the plurality of metaverse environments corresponds to a geographic area and a time period;
identifying two or more metaverse environments of the plurality of metaverse environments that are at least partially coincident;
identifying objects in each of the two or more metaverse environments, wherein each of the objects includes a tag identifying a type of the object;
receiving, from a user, a filter specifying types of the objects to be included in a merged metaverse environment; and
creating, based on the two or more metaverse environments, the merged metaverse environment by combining the objects from the two or more metaverse environments based on the filter.
